(19) United States
(12) Patent Application Publication
(10) Pub. No.: US 2011/0047961 A1
(43) Pub. Date: Mar. 3, 2011

(54) PULSE DETONATION INLET MANAGEMENT SYSTEM

(75) Inventors: Ross Hartley Kenyon, Waterford, NY (US); James Fredric Wiedenhoefer, Clifton Park, NY (US); Adam Rasheed, Glenville, NY (US); Narendra Digamber Joshi, Schenectady, NY (US)

(73) Assignee: GENERAL ELECTRIC COMPANY, SCHENECTADY, NY (US)

(21) Appl. No.: 12/549,920

(22) Filed: Aug. 28, 2009

(51) Int. Cl. F02C 5/12

(52) U.S. Cl. 60/247; 251/318

(57) ABSTRACT

A pulse detonation combustor valve assembly is provided that includes a fixed valve portion having an inlet and a reciprocating valve portion. The valve assembly is coupled to a pulse detonation combustor. The reciprocating valve portion is exterior to the fixed valve portion and coaxially aligned with the fixed valve portion. The reciprocating valve portion is arranged to reciprocate with respect to the fixed valve portion to control inlet flow through the inlet of the valve assembly.

### BACKGROUND

With the development of pulse detonation combustors (PDCs) and engines (PDEs), various efforts have been made to use this technology in practical applications. An example of such a practical application is the development of a “hybrid” engine that uses a combination of both conventional gas turbine engine technology and PDE technology to maximize operation efficiency. Other examples include use in aircrafts, missiles, and rockets.

Pulse detonation combustors are used, for example, in pulse detonation engines. In pulse detonation engines, thrust is generated by the supersonic detonation of fuel in a detonation chamber. The supersonic detonation increases the pressure and temperature in the detonation chamber until it is released resulting in thrust. The detonation process is efficient since all of the charge is burned while inside the detonation chamber. As with any engine that intakes air, inlet stability is an important aspect of maintaining proper operation of a pulse detonation engine. This presents a particular challenge in pulse detonation engines, which use open inlet tubes.

The operation of pulse detonation engines creates extremely high pressure peaks and oscillations within the combustor that may travel to upstream components, and generates high heat within the combustor and surrounding components resulting in damage and malfunction of the upstream components. Consequently, various valving techniques are being developed to provide inlet control and prevent the high pressure peaks from traveling to the upstream components.

For these and other reasons, there is a need for the present invention.

### SUMMARY

A pulse detonation combustor valve assembly is provided that includes a fixed valve portion having an inlet and a reciprocating valve portion. The valve assembly is coupled to a pulse detonation combustor. The reciprocating valve portion is exterior to the fixed valve portion and coaxially aligned with the fixed valve portion. The reciprocating valve portion is arranged to reciprocate with respect to the fixed valve portion to control inlet flow through the inlet of the valve assembly.

### BRIEF DESCRIPTION OF THE DRAWINGS

Embodiments of the invention are better understood with reference to the following drawings. Like reference numerals represent corresponding parts.

FIGS. 1A-1C show cross-sectional views of an exemplary embodiment of a pulse detonation combustor valve assembly;

FIGS. 2A-2C show cross-sectional views of another exemplary embodiment of a pulse detonation combustor valve assembly;

FIGS. 3A and 3B show a cross-sectional view yet another embodiment of a pulse detonation combustor valve assembly;

FIG. 4 shows an exemplary embodiment of sealing elements;

FIG. 5 shows another exemplary embodiment for fuel injection;

FIG. 6 shows the operational stages of an exemplary embodiment of a pulse detonation combustor valve assembly;

FIG. 7 shows the operating stages of an exemplary embodiment of a pulse detonation combustor valve assembly; and

FIG. 8 shows an exemplary operating cycle of a pulse detonation combustor valve assembly.

### DETAILED DESCRIPTION

As used herein, a “pulse detonation combustor” (PDC) is understood to mean any device or system that produces both a pressure rise and velocity increase from a series of repeated detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs include a means of igniting a fuel/oxidizer mixture, for example a fuel/air mixture, and a detonation chamber, in which pressure wave fronts initiated by the ignition process coalesce to produce a detonation or quasi-detonation. Each detonation or quasi-detonation is initiated either by external ignition, such as spark discharge or laser pulse, or by gas dynamic processes, such as shock focusing, auto ignition or by another detonation (i.e. cross-fire). PDCs are used in pulse detonation engines (PDEs), for example. As used herein, “engine” means any device used to generate thrust and/or power. As used herein, “detonation” includes both detonations and quasi-detonations.

Embodiments of the present invention will be explained in further detail by making reference to the accompanying drawings in which like reference numerals indicate corresponding parts. The drawings do not limit the scope of the invention in any way.

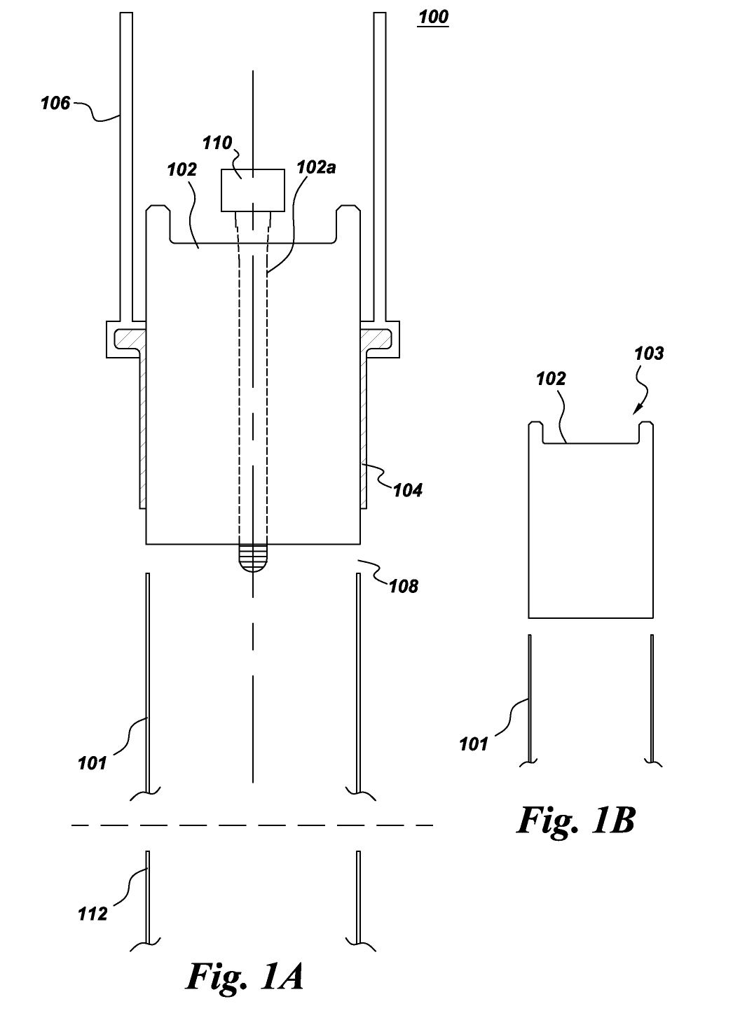

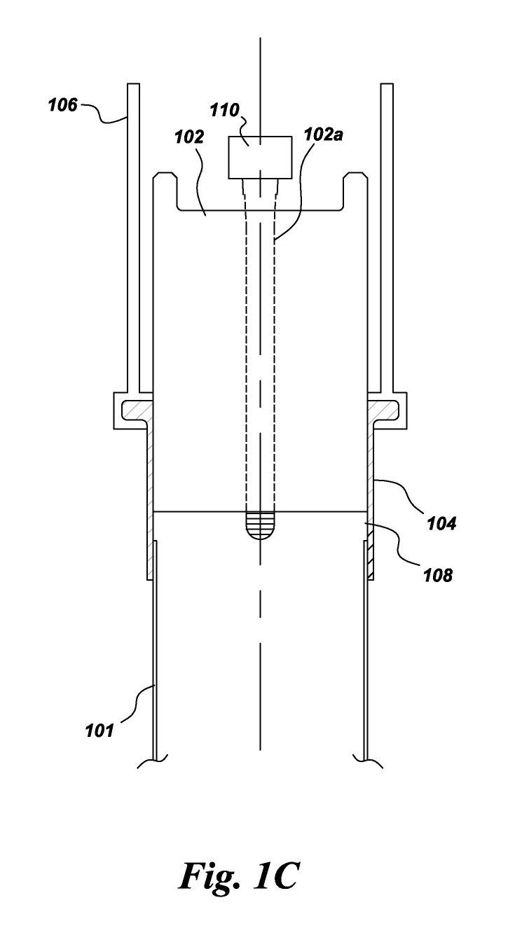

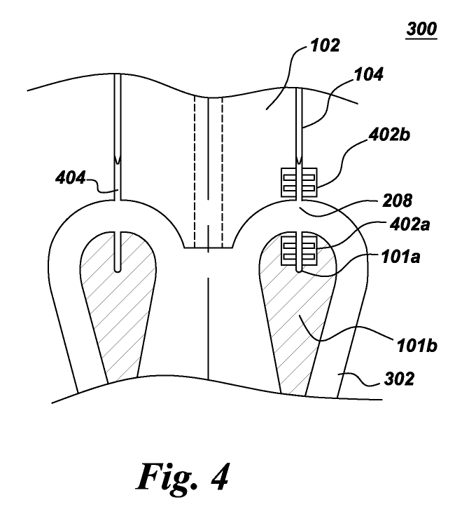

FIGS. 1A-1C depict a pulse detonation combustor valve assembly 100 according to an exemplary embodiment of the present invention. The assembly 100 includes a fixed valve portion 103 and a reciprocating valve portion 104. The fixed valve portion 103 includes a fixed base member 101 and a fixed end cap 102, as shown in FIG. 1B. In the embodiment shown, the fixed base member 101 and the fixed end cap 102 are axially aligned. The reciprocating valve portion 104 reciprocates with respect to the fixed valve portion 103 to periodically occlude an inlet 108. Seal elements, such as labyrinth seals shown in FIG. 4, are arranged between the fixed valve portion and the reciprocating valve portion 104. The seal elements can be any suitable seal element to accomplish the desired seal. The inlet 108 provides for the flow of an oxidizer, such as air, through the assembly. The invention is not limited to controlling the flow of oxidizer. The valve assembly can also used to control the flow of fuel or a fuel and oxidizer mixture through the inlet.

The fixed valve portion 103 is axially aligned with the reciprocating valve 104. The shape and size of the fixed valve portion 103 and the reciprocating valve portion 104 can be determined based upon the desired performance characteristics and the application. In the exemplary embodiment, the fixed valve portion 103 and the reciprocating valve portion 104 are cylinders arranged concentrically. In addition, fuel is supplied axially from a fuel injector 110 via a passage 102a arranged in the fixed valve portion 103. FIG. 1A shows the valve assembly 100 where the reciprocating valve portion 104 is open, and FIG. 1C illustrates the valve assembly 100 where the reciprocating valve portion 104 is closed blocking the inlet 108.

In FIGS. 1A-1C, the inlet 108 is formed from an annular arrangement of the fixed base member 101 and the fixed end cap 102. However, the inlet 108 can also be formed as holes, slots, or any other suitable openings in the fixed base member 101. A fluidic device (not shown) can be provided at the inlet to reduce pressure drop at the inlet 108 by avoiding flow separation.

Actuation of the reciprocating valve portion 104 can be accomplished by any suitable means including mechanical (cam, scotch yoke, spring-mass-damper systems), pneumatic, electromagnetic, hydraulic, etc. For purposes of discussion, push-rods 106 are shown as part of an exemplary actuation device. The valve assembly 100 can be supported by any suitable support structure.

In FIGS. 1A-1C, fuel is injected axially from the fuel injector 110. However, fuel can be injected through an opening arranged on the side of the fixed base member 101. Fuel can be injected downstream from the inlet 108 or upstream of the inlet 108. Fuel can either be liquid fuel or gaseous fuel.

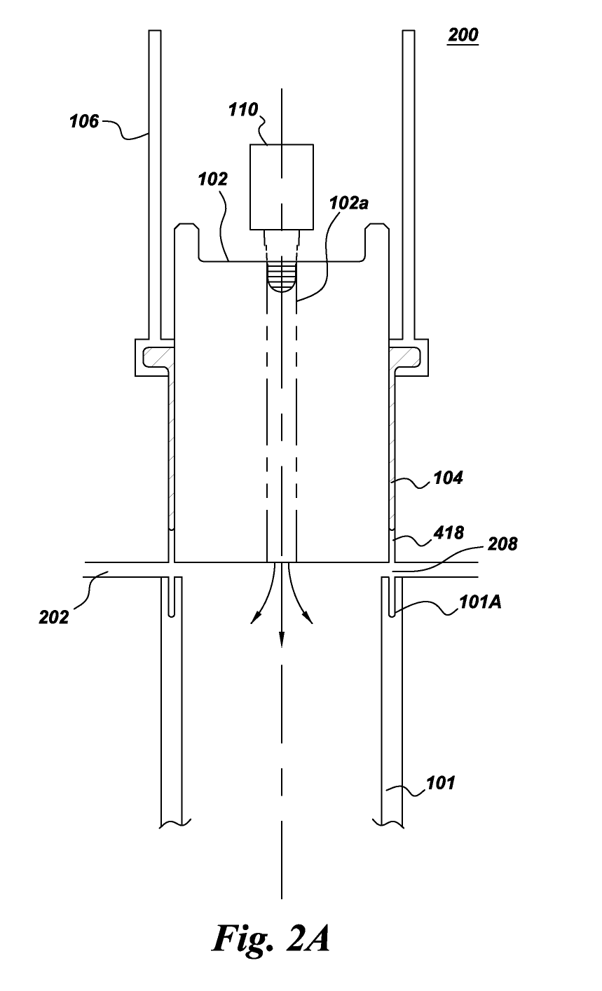

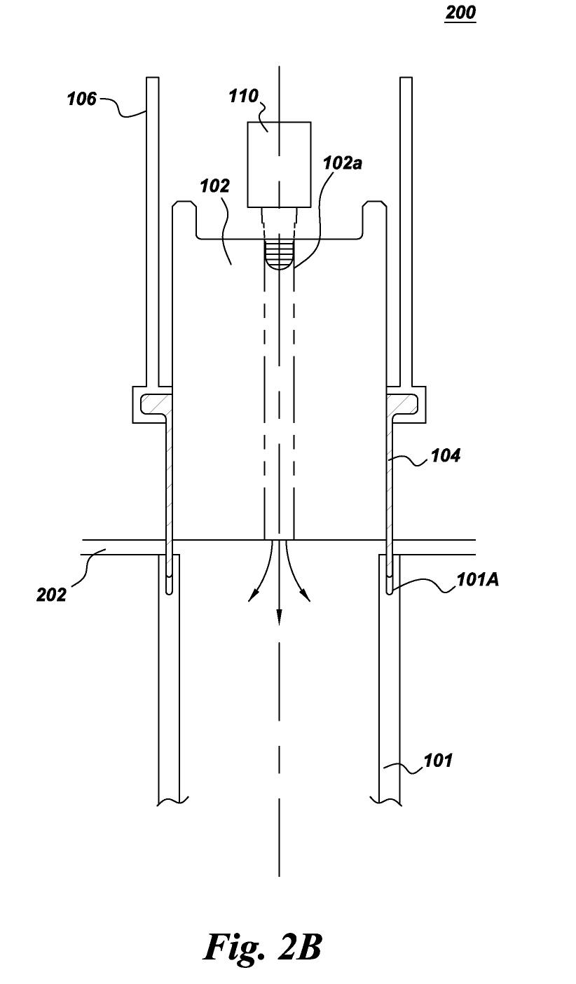

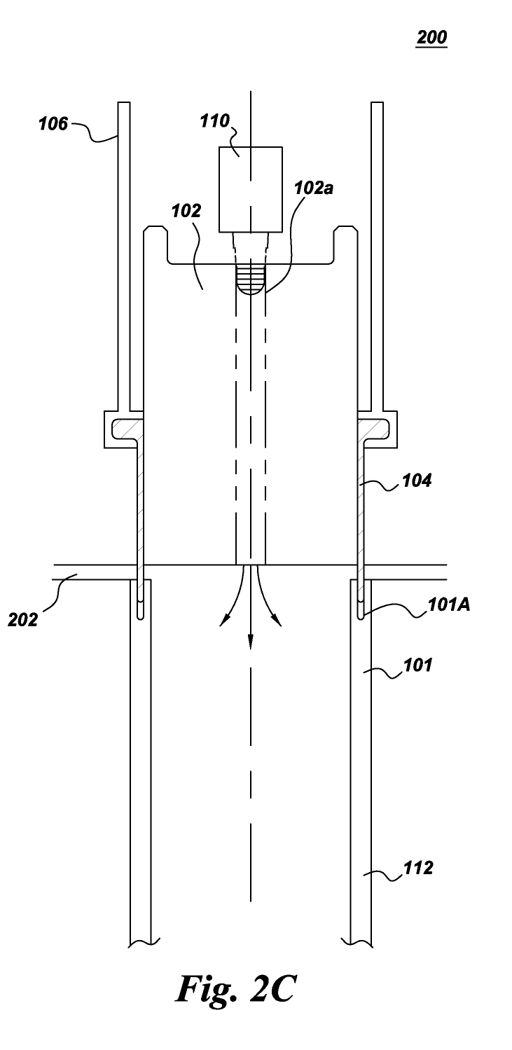

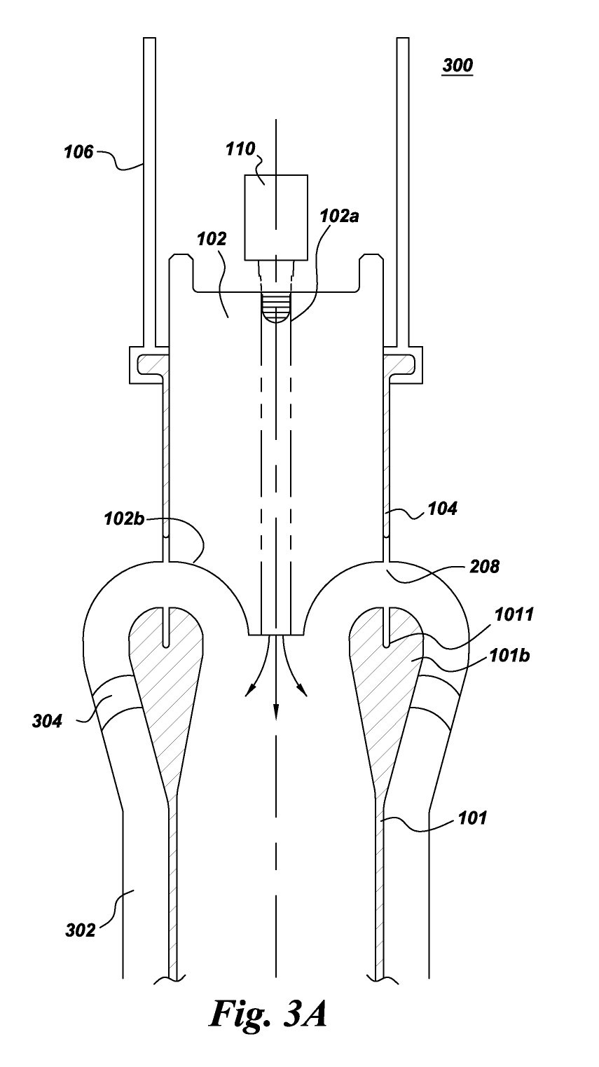

FIGS. 2A and 2B depict another embodiment of a pulse detonation combustor valve assembly. The assembly 200 includes the fixed valve portion 103, the reciprocating valve portion 104, an inlet passage 202, and an inlet 208. As in the previous embodiment, fuel is supplied from the fuel injector 110 via a passage 102a in the fixed valve portion 103. In this embodiment, the fixed base member 101 includes a receptacle 101a. The receptacle 101a is arranged in the fixed base member 101 opposite the reciprocating valve portion 104. The receptacle 101a receives the reciprocating valve portion 104 during valve operation to prevent flow through the inlet 208.

The reciprocating valve portion 104 reciprocates with respect to the receptacle 101b in the fixed base member 101 to periodically occlude the inlet 208 to control flow through the valve assembly. In FIG. 2A, the reciprocating valve portion 104 is shown in the open position, while in FIG. 2B, the reciprocating valve portion 104 is shown in the closed position. Actuation of the reciprocating valve portion 104 can be accomplished by any suitable means as described with respect to previous embodiments. For purposes of discussion, push-rods 106 are shown as part of an exemplary actuation device.

Each of the valve assemblies shown in FIGS. 1A-1C and 2A-2B can be used in any device requiring valve operation to control inlet flow. For example, the valve assemblies can be used in any combustion/detonation device. In a more specific example, the valve assembly is coupled to a pulse detonation combustor 112, as shown in FIG. 1A. The fixed base member 101 of the assembly 100 can be attached to the pulse detonation combustor by any suitable means such as by flanges, welding, etc. Alternatively, the fixed base member 101 of the valve assembly can be formed as an integral part of a pulse detonation combustor 112. More specifically, the fixed base member 101 and the pulse detonation combustor 112 can be formed as a continuous structure, as shown in FIG. 2C. Operation of the valve assembly in FIG. 2C is the same as in FIGS. 2A and 2B.

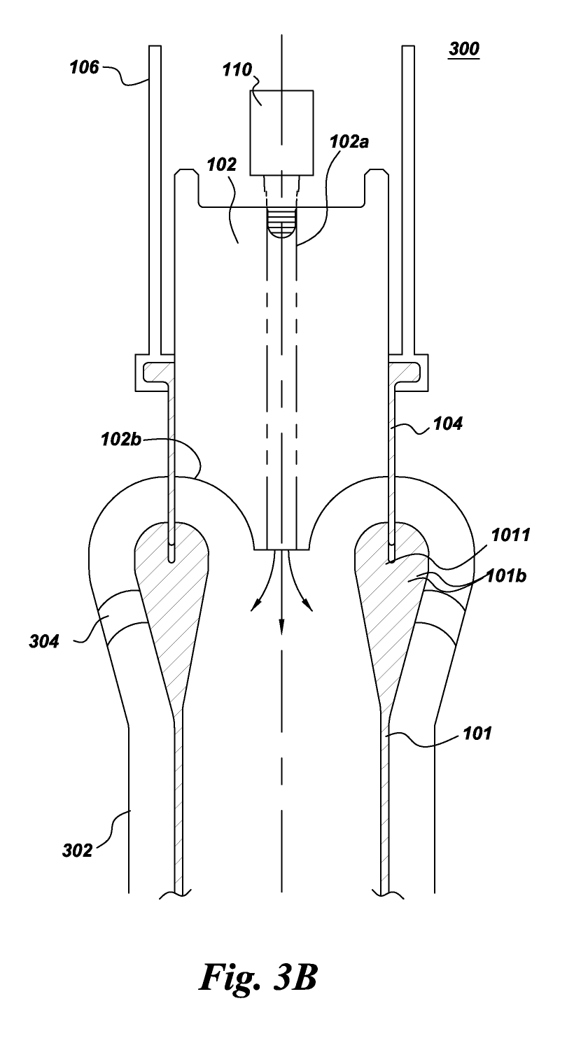

FIGS. 3A and 3B illustrate another exemplary embodiment of the present invention. In this embodiment, the fixed base member 101 tapers to an aerodynamic member 101b that includes the receptacle 101a. In addition, the inlet passage 202 is replaced with an annulus or inlet passage 302 that is curved to correspond to the aerodynamic member 101b of the fixed base member 101. In addition, the fixed end cap 102 of the fixed valve portion 103 in this embodiment includes a curved portion 102b. The curved portion 102b continues the curve of the inlet passage 302. The curved portion 102b also corresponds to the curve of the aerodynamic member 101b. As in previous embodiments, the reciprocating valve portion 104 reciprocates with respect to the fixed valve portion 103 to periodically occlude the inlet passage 302. The reciprocating valve portion 104 is open in FIG. 3A, and closed in FIG. 3B.

The inlet passage 302 is not limited to an annular structure, and can be formed in any manner suitable to the application. Further, the inlet passage 302 can include one or more vanes 304. The vanes 304 provide structural support to the inlet passage 302 and can be configured to induce swirl in the incoming airflow. The swirl together with the aerodynamic member 101b and the curved portion 102b serve to prevent flow separation and thus reduce aerodynamic losses. The amount of swirl and the geometry of the aerodynamic member 101b can be adjusted to improve fuel-air mixing and promote more efficient detonations.

Referring to FIG. 4, seal elements 402a and 402b are provided to seal the receptacle 101a and the space 404 in which the reciprocating valve portion 104 reciprocates, respectively. In the exemplary embodiment shown, the seal elements 402a and 402b are labyrinth seals. However, any suitable seal elements can be used that will ensure that the pressure rise is sufficiently maintained within the pulse detonation combustor. The seal elements 402a, 402b ensure proper flow of oxidizer through inlet passage so that flow is not lost in the space 404 or in the receptacle 101a. The seal elements prevent the pressure rise from passing to any upstream components. The location of the seal elements is not limited to those shown in FIG. 4. They may be positioned in any suitable location to achieve the sealing results.

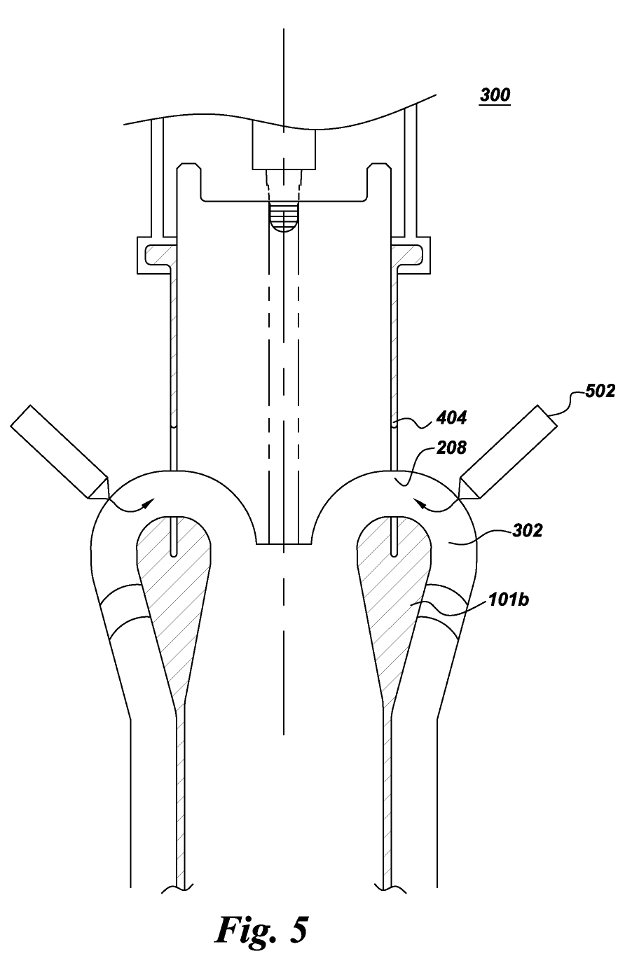

In the previous exemplary embodiments, the fuel injector 110 is axially aligned with the fixed valve portion 103 and the reciprocating valve portion 104. However, fuel may also be supplied downstream of the reciprocating valve portion 104 by injectors 502 arranged in the inlet passage 302, as shown in FIG. 5. Of course, fuel may be injected in any manner suitable to the specific structure and application. Alternatively, fuel can be injected into the pulse detonation combustor 112.

As previously noted, the actuator mechanism for each of the embodiments discussed may be selected from any number of known actuators. Also, the reciprocating valve portion 104 and the fixed valve portion 103 can be cylindrical or cylindrical through a portion of their length. However, embodiments of the invention are not limited to a cylinder and the valve assembly can be of any shape suitable for the application.

The embodiments described above provide for the reciprocation of the reciprocating valve portion 104 to modulate the flow through the inlet with very small pressure drop. The aerodynamic member 101b prevents flow separation and minimizes aerodynamic losses.

The reciprocating valve portion 104 and the fixed valve portion 103 according to the exemplary embodiments of the present invention significantly reduce the forces and loads experienced by upstream components, which simplifies operation and extends the operational life of the system. The valve assembly enables the detonation load to be balanced radially. Very little, if any, forces will be experienced axially. Therefore, the components coupled to the valve assembly (for example, its driving mechanism) will be shielded from the damaging pressure oscillations.

The valve assembly according to embodiments of the present invention enables the inlet passage to be opened and closed quickly. In operation, the reciprocating valve portion traverses a relatively short axial distance. However, the reciprocating valve portion and the fixed valve portion can have a relatively large opening. Therefore, the physical opening of the valve assembly will change rapidly with small reciprocating movement. As a consequence, flow through the valve assembly can be optimized.

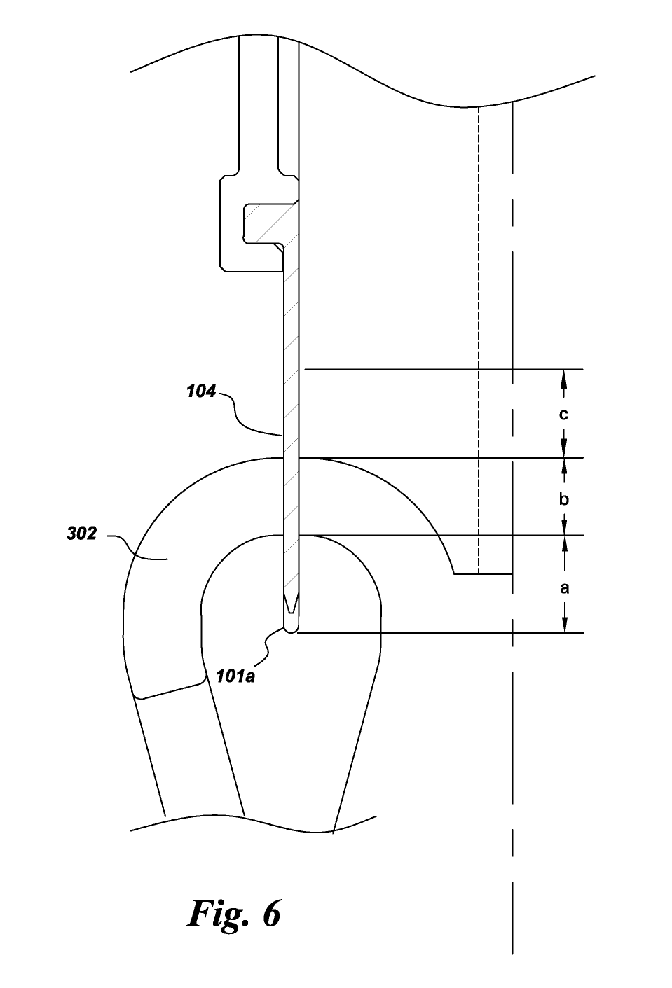

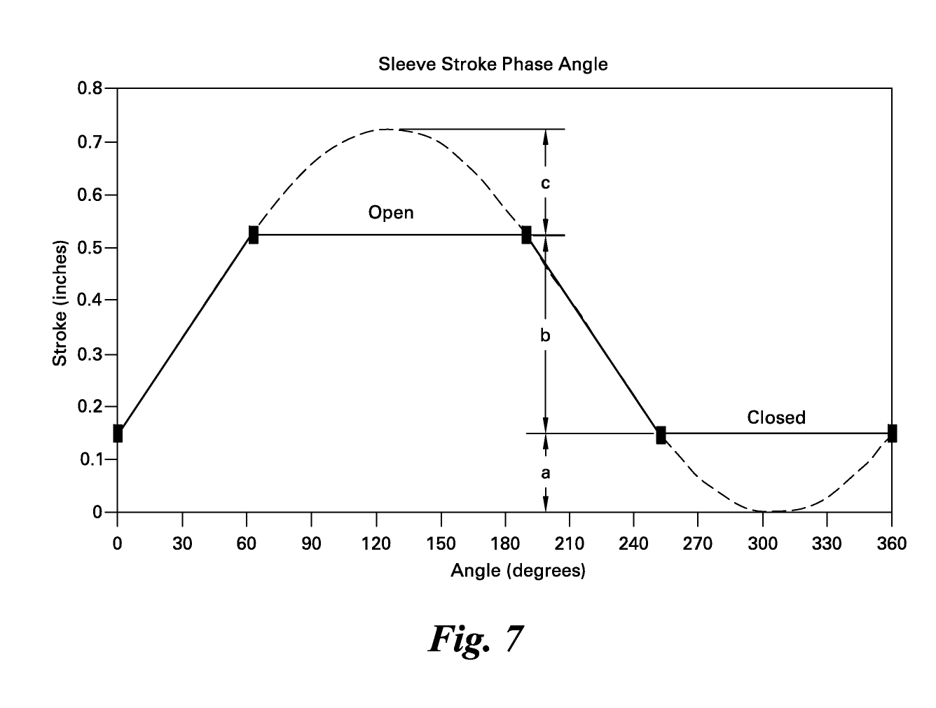

Operation of the valve assembly will be discussed in more detail. As shown in FIGS. 6 and 7, the entire stroke length is represented by a+b+c. The stroke length of a, b, and c parameters can be adjusted to change the valve timing and increase/decrease the valve opening time. Variable geometry elements can be incorporated into the actuation mechanism to adjust timing on the fly if desired. In the embodiment shown, the reciprocating valve portion reciprocates from Top Dead Center (TDC) to Bottom Dead Center (BDC).

During the upstroke, the reciprocating valve portion begins to open as the tip exits the receptacle. The valve assembly is fully open once the tip has cleared the inlet opening and is fully open for the duration of time until the tip of the reciprocating valve portion begins to occlude the inlet, as shown in FIG. 7. On the downstroke, when the reciprocating valve portion enters the receptacle, it is considered fully closed. The valve assembly is fully closed for the duration of the time that the reciprocating valve portion is within the receptacle, as shown in FIG. 7. According to embodiments of the invention, the opening of the valve assembly can be large relative to the axial distance b traversed by the reciprocating valve portion. This provides for a smaller axial stroke and less loads or demands on the actuating mechanism to achieve optimal performance.

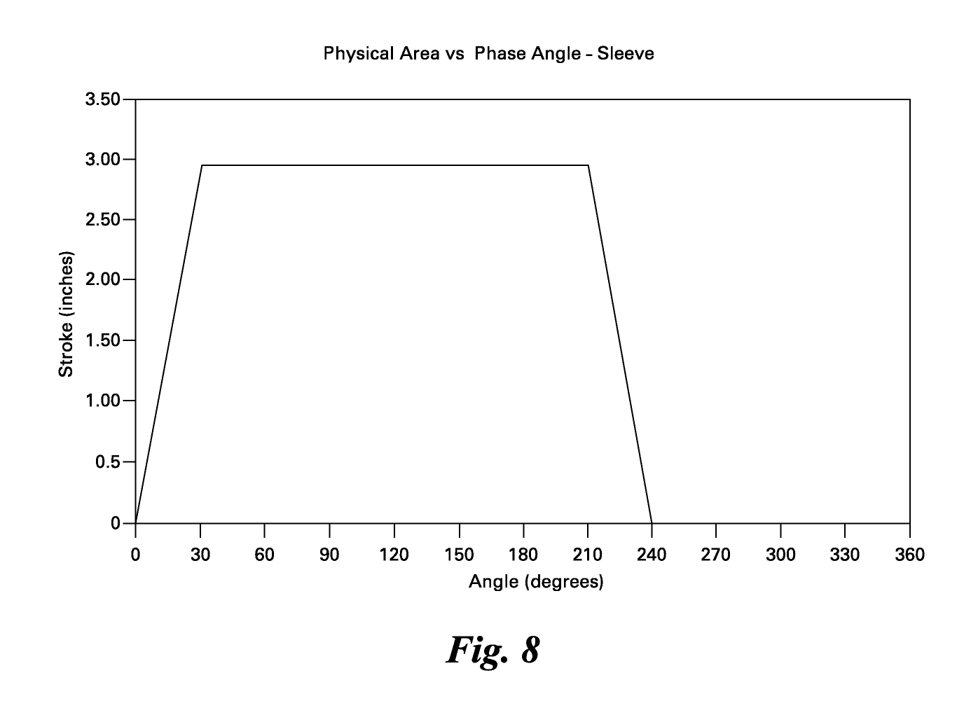

As discussed above and shown in FIG. 8, the valve assembly reaches fully open and fully closed positions rapidly. This allows for maximized time open.

Additionally, depending on the desired operational performance, the rate of reciprocation of the reciprocating valve portion can be constant or it can be variable based on various performance and operational requirements. Further, the rate of reciprocation can be changed or adjusted to change the fill profile of the combustor or other device chamber to be filled to achieve the desired operation. The rate of reciprocation can be controlled by any known means, such as through the use of a computer control system, stepper motors, and the like.

As described herein, embodiments of the arrangement of the valve assembly and the inlet passage provide for an efficient filling phase with very small pressure drop, which increases engine performance and/or efficiency. The valve assembly also balances mechanical loads from combustion pressure. The symmetry of the system allows for very strong components while being lightweight.

It is noted that the above embodiments have been shown and described with respect to a single pulse detonation combustor (or device chamber). However, the concept of the present invention is not limited to single pulse detonation combustor embodiments.

It is noted that although embodiments of the present invention have been discussed above with respect to aircraft and power generation applications, the present invention is not limited to this and can be in any similar detonation/deflagration device in which the benefits of the present invention are desirable.

While the invention has been described in terms of various specific embodiments, those skilled in the art will recognize that the invention can be practiced with modification within the spirit and scope of the claims.

What is claimed is:

1. A pulse detonation combustor valve assembly, comprising:
a fixed valve portion having an inlet;
a reciprocating valve portion coaxially aligned with the fixed valve portion and arranged to reciprocate about an exterior of at least a portion of the fixed valve portion to control inlet flow through the inlet; and
a pulse detonation combustor coupled to the fixed valve portion.

2. The pulse detonation combustor valve assembly of claim 1, wherein the fixed valve portion and the reciprocating valve portion are arranged concentrically.

3. The pulse detonation combustor valve assembly of claim 1, wherein the fixed valve portion and the reciprocating valve portion are cylinders.

4. The pulse detonation combustor valve assembly of claim 1, wherein the inlet comprises an opening in the fixed valve portion.

5. The pulse detonation combustor valve assembly of claim 1, wherein the fixed valve portion comprises a fixed base member and a fixed end cap.

6. The pulse detonation combustor valve assembly of claim 5, wherein the inlet comprises an annulus formed by the fixed base member and the fixed end cap of the fixed valve portion.

7. The pulse detonation combustor valve assembly of claim 5, wherein the inlet comprises an opening in the fixed base member.

8. The pulse detonation combustor valve assembly of claim 5, wherein the fixed base member is coupled to the pulse detonation combustor.

9. The pulse detonation combustor valve assembly of claim 5, wherein the fixed base member and the pulse detonation combustor comprise a single, continuous structure.

10. The pulse detonation combustor valve assembly of claim 1, further comprising an inlet passage coupled to the inlet, wherein the inlet passage comprises at least one vane.

11. The pulse detonation combustor valve assembly of claim 1, wherein reciprocation of the reciprocating valve portion is varied based upon ignition requirements of the pulse detonation combustor.

12. The pulse detonation combustor valve assembly of claim 1, wherein the fixed valve portion and the pulse detonation combustor comprise a single, continuous structure.

13. The pulse detonation combustor valve assembly of claim 1, wherein the fixed valve portion comprises an aerodynamically tapered portion proximate to the inlet.

14. The pulse detonation combustor valve assembly of claim 13, further comprising a curved inlet passage coupled to the inlet and arranged to correspond to the aerodynamically tapered portion of the fixed valve portion.

15. The pulse detonation combustor valve assembly of claim 1, further comprising a seal arranged between the fixed valve portion and the reciprocating valve portion.

16. The pulse detonation combustor valve assembly of claim 1, wherein the fixed valve portion comprises a fuel passage to supply fuel from a fuel supply to the pulse detonation combustor.

17. The pulse detonation combustor valve assembly of claim 1, wherein the reciprocating valve portion reciprocates to control the flow of oxidizer through the inlet.

18. The pulse detonation combustor valve assembly of claim 1, wherein the reciprocating valve portion reciprocates to control the flow of a fuel-oxidizer mixture through the inlet.

19. The pulse detonation combustor valve assembly of claim 1, further comprising a fluidic device arranged proximate to the inlet to reduce pressure drop at the inlet.

20. A pulse detonation combustor valve assembly, comprising:
a fixed valve portion having a receptacle and an inlet;
a reciprocating valve portion coaxially aligned with the fixed valve portion and arranged to reciprocate with respect to the fixed valve portion, wherein the receptacle is arranged to receive the reciprocating valve portion during a reciprocating operation; and
a pulse detonation combustor coupled to the fixed valve portion.

21. The pulse detonation combustor valve assembly of claim 20, wherein the fixed valve portion and the reciprocating valve portion are arranged concentrically.

22. The pulse detonation combustor valve assembly of claim 20, wherein the fixed valve portion and the reciprocating valve portion are cylinders.

23. The pulse detonation combustor valve assembly of claim 20, wherein the inlet comprises an opening in the fixed valve portion.

24. The pulse detonation combustor valve assembly of claim 20, wherein the fixed valve portion comprises a fixed base member and a fixed base cap.

25. The pulse detonation combustor valve assembly of claim 24, wherein the inlet comprises an annulus formed by the fixed base member and the fixed end cap of the fixed valve portion.

26. The pulse detonation combustor valve assembly of claim 24, wherein the inlet comprises an opening in the fixed base member.

27. The pulse detonation combustor valve assembly of claim 24, wherein the fixed base member is coupled to the pulse detonation combustor.

28. The pulse detonation combustor valve assembly of claim 24, wherein the fixed base member and the pulse detonation combustor comprise a single, continuous structure.

29. The pulse detonation combustor valve assembly of claim 20, further comprising an inlet passage coupled to the inlet, wherein the inlet passage comprises at least one vane.

30. The pulse detonation combustor valve assembly of claim 20, wherein the fixed valve portion and the pulse detonation combustor comprise a single, continuous structure.

31. The pulse detonation combustor valve assembly of claim 20, wherein the fixed valve portion comprises an aerodynamically tapered portion proximate to the inlet.

32. The pulse detonation combustor valve assembly of claim 20, further comprising a seal coupled to the receptacle in the fixed valve portion.

33. The pulse detonation combustor valve assembly of claim 20, wherein the fixed valve portion comprises a fuel passage to supply fuel from a fuel supply to the pulse detonation combustor.

34. The pulse detonation combustor valve assembly of claim 20, wherein the reciprocating valve portion reciprocates to control the flow of oxidizer through the inlet.

35. The pulse detonation combustor valve assembly of claim 20, wherein the reciprocating valve portion reciprocates to control the flow of a fuel-oxidizer mixture through the inlet.

36. The pulse detonation combustor valve assembly of claim 20, further comprising a curved inlet passage coupled to the fixed valve portion.

37. The pulse detonation combustor valve assembly of claim 31, further comprising a curved inlet passage coupled to the fixed valve portion and having a curved portion corresponding to the aerodynamic portion of the fixed valve portion.

38. The pulse detonation combustor valve assembly of claim 37, wherein the fixed valve portion comprises a fixed base member and a fixed end cap, and wherein the fixed base member comprises the aerodynamic portion and wherein the fixed end cap comprises a curved portion corresponding to the aerodynamic portion of the fixed base member.

39. The pulse detonation combustor valve assembly of claim 36, wherein the curved inlet passage comprises at least one vane.

40. The pulse detonation combustor valve assembly of claim 20, further comprising an actuator coupled to the reciprocating valve portion.

41. The pulse detonation combustor valve assembly of claim 40, wherein the actuator is one of a mechanical, electromagnetic, pneumatic, or hydraulic actuator.

42. The pulse detonation combustor valve assembly of claim 20, wherein reciprocation of the reciprocating valve portion is varied based upon ignition requirements of the pulse detonation combustor.

43. The pulse detonation combustor valve assembly of claim 20, further comprising a fluidic device arranged proximate to the inlet to reduce pressure drop at the inlet.

44. An engine, comprising:
a fixed valve portion having an inlet;
a reciprocating valve portion coaxially aligned with the fixed valve portion and arranged to reciprocate about an exterior of at least a portion of the fixed valve portion to control inlet flow through the inlet; and
a pulse detonation combustor coupled to the fixed valve portion.

45. An engine, comprising:
a fixed valve portion having a receptacle and an inlet;
a reciprocating valve portion coaxially aligned with the fixed valve portion and arranged to reciprocate with respect to the fixed valve portion, wherein the receptacle is arranged to receive the reciprocating valve portion during a reciprocating operation; and
a pulse detonation combustor coupled to the fixed valve portion.
